(19) United States
(12) Patent Application Publication
(10) Pub. No.: US 2025/0039744 A1
(43) Pub. Date: Jan. 30, 2025

(54) METHOD AND DEVICES FOR COGNITIVE RADIO

(71) Applicant: SILVUS TECHNOLOGIES, INC., Los Angeles, CA (US)

(72) Inventors: Mansour Rachid, Los Angeles, CA (US); Babak Daneshrad, Los Angeles, CA (US); Matthew Hayes, Los Angeles, CA (US)

(21) Appl. No.: 18/784,527

(22) Filed: Jul. 25, 2024

Related U.S. Application Data
(60) Provisional application No. 63/515,784, filed on Jul. 26, 2023.

(51) Int. Cl. H04W 28/18; H04B 7/0413; H04W 84/18

(52) U.S. Cl. CPC H04W 28/18; H04B 7/0413; H04W 84/18

(57) ABSTRACT

Aspects of this disclosure relate to a radio may include a transceiver configured to communicate signal packets. A radio may include a memory configured to store a multilayer process. A radio may include hardware processors in communication with the memory. The hardware processors may be configured to identify transmission parameter data at a time period between successful communications of the signal packets, store the transmission parameter data in a buffer in the memory, pass the transmission parameter data to the multilayer process to determine a plurality of potential operating configurations comprising at least one of a power operational setting, a frequency operational setting, a multiple-input multiple-output operational setting, or a time operational setting, arbitrate the plurality of potential operating configurations to determine a final set of operating configurations; and update operation of the radio based on the final set of operating configurations.

### CROSS-REFERENCE TO RELATED APPLICATIONS

This application claims the benefit of U.S. Provisional Application Ser. No. 63/515,784, filed Jul. 26, 2023, entitled “METHOD AND DEVICES FOR COGNITIVE RADIO,” which is incorporated by reference herein in its entirety. Any and all applications for which a foreign or domestic priority claim is identified in the Application Data Sheet as filed with the present application are hereby incorporated by reference under 37 CFR 1.57.

### BACKGROUND

The disclosed subject matter relates to the fields of wireless communication, machine learning, and artificial intelligence. Wireless devices have become a mainstay in the daily lives of many people, who may depend upon such devices for reliable mobile communication in nearly any situation. Military users and members of law enforcement rely upon tactical radios, walkie-talkies, and other wireless devices to communicate in a variety of scenarios, some of which may even be life-threatening, including but not limited to battlefield operations, military exercises and missions, emergency situations, natural disasters, and others. In these and other situations, there is continuing demand for increased reliability, higher data rates, faster speeds, and better connectivity, and the wireless spectrum continues to become more congested as a result. Wireless devices also may need to overcome interference, both deliberate and unintentional. The capabilities of wireless devices may benefit from techniques that address challenges like those described above or others.

### SUMMARY OF THE INVENTION

For purposes of summarizing the disclosure, certain aspects, advantages and novel features have been described herein. It is to be understood that not necessarily all such advantages can be achieved in accordance with any particular embodiment disclosed herein. Thus, the embodiments disclosed herein can be embodied or carried out in a manner that achieves or optimizes one advantage or group of advantages as taught or suggested herein without necessarily achieving others.

In some embodiments, a radio is described. The radio can include a transceiver configured to communicate signal packets, a memory configured to store a multilayer process, and one or more hardware processors in communication with the memory. The one or more hardware processors can be configured to identify transmission parameter data at a time period between successful communications of the signal packets, store the transmission parameter data in a buffer in the memory, pass the transmission parameter data to the multilayer process to determine a plurality of potential operating configurations including at least one of a power operational setting, a frequency operational setting, a multiple-input multiple-output operational setting, or a time operational setting, arbitrate the plurality of potential operating configurations to determine a final set of operating configurations, and update operation of the radio based on the final set of operating configurations.

In some embodiments, the transceiver is configured to communicate the signal packets with different multiple-input multiple-output (“MIMO”) radios of a mobile ad-hoc network (MANET). In some embodiments, the transmission parameter data is identified after a failed data packet. In some embodiments, the one or more hardware processors are configured to pass the transmission parameter data to the multilayer process when the buffer is full. In some embodiments, the one or more hardware processors are configured to continuously pass the transmission parameter data to the multilayer process. In some embodiments, the memory is further configured to store one or more machine learning algorithms. In some embodiments, the one or more hardware processors are configured to arbitrate the plurality of potential operating configurations to determine the final set of operating configurations using at least one machine learning algorithm of the one or more machine learning algorithms. In some embodiments, the at least one machine learning algorithm of the one or more machine learning algorithms is trained using stored information of interference simulations. In some embodiments, the interference simulations include multiple configurations of interferes and geographic distributions of a plurality radios. In some embodiments, the one or more machine learning algorithms are further trained or re-trained using interference measurements collected in an environment over time. In some embodiments, the transmission parameter data includes at least one of signal-to-noise ratio at the radio, detection of interference, jammer-to-noise ratio, jammer bandwidth, or throughput at the radio. In some embodiments, the multilayer process includes two or more of a transmit power control engine, a noise-like spread signaling engine, a decoy relays engine, a directional radiation engine, an interference cancellation engine, or an interference avoidance engine. In some embodiments, the transceiver is configured for multiple-input multiple output (“MIMO) communication. In some embodiments, the one or more hardware processors are further configured to manipulate interference cancellation through processing information from multiple receive antennas of the transceiver. In some embodiments, the one or more hardware processors are further configured to receive a user defined condition metric associated with one or more predetermined operating conditions for the radio and arbitrate the plurality of potential operating configurations and the user defined condition metric to determine the final set of operating configurations. In some embodiments, the one or more predetermined operating conditions includes at least one of undetectability, throughput, quality of service, and connectivity.

In some embodiments, a method of operating a radio is provided. The method can include identifying transmission parameter data at a time period between successful communication of signal packets, storing the transmission parameter data in a buffer in a memory, passing the transmission parameter data to a multilayer process stored in the memory to determine a plurality of potential operating configurations including at least one of a power operational setting, a frequency operational setting, a multiple-input multiple-output operational setting, or a time operational setting, arbitrating the plurality of potential operating configurations to determine a final set of operating configurations, and updating operation of the radio based on the final set of operating configurations.

In some embodiments, the transmission parameter data is identified after a failed data packet. In some embodiments, passing the transmission parameter data to the multilayer process includes passing the transmission parameter data to the multilayer process when the buffer is full. In some embodiments, arbitrating the plurality of potential operating configurations including using at least on machine learning algorithm trained using stored information of interference simulations. In some embodiments, the multilayer process includes two or more of a transmit power control engine, a noise-like spread signaling engine, a decoy relays engine, a directional radiation engine, an interference cancellation engine, or an interference avoidance engine. In some embodiments, the method further includes manipulating interference cancellation through processing information from multiple receive antennas of a multiple-input multiple output transceiver.

In some embodiments, a method for configuring a cognitive networking device is provided. The method can include receiving transmission parameters for a transmission channel, wherein the transmission parameters include at least one of signal-to-noise ratio at the cognitive networking device, detection of interference, jammer-to-noise ratio, jammer bandwidth, and throughput at the cognitive networking device. The method can further include receiving user defined condition metrics, wherein the condition metrics include priority information associated with one or more predetermined operating conditions for the cognitive networking device. The method can further include determining, using one or more machine learning algorithms, an operating configuration based on at least one of the transmission parameters and the condition metrics, wherein the one or more machine learning algorithms are trained from one or more databases including at least stored information of interference simulations. The method can further include configuring one or more operational engines on the cognitive networking device based on the operating configuration.

In some embodiments, the interference simulations include multiple configurations of interferes and geographic distributions of a plurality of cognitive networking devices. In some embodiments, the one or more predetermined operating conditions includes at least one of undetectability, throughput, quality of service, and connectivity. In some embodiments, the one or more operational engines include at least one of a transmit power control engine, a noise-like spread signaling engine, a decoy relays engine, a directional radiation engine, an interference cancellation engine, and an interference avoidance engine. In some embodiments, configuring one or more operational engines includes: enabling at least one of the one or more operational engines, and controlling one or more input parameters for each enabled operational engine. In some embodiments, the one or more machine learning algorithms are further trained or re-trained using at least one of interference measurements collected in an environment over time and previous responses from one of the one or more machine learning algorithms.

In some embodiments, a method for interference classification using a cognitive networking device is provided. The method can include determining, for a transmission channel, a potential interference signal. The method can further include determining, using one or more machine learning algorithms, the potential interference signal is an interference event. The method can further include associating, using the one or more machine learning algorithms, the interference event with an interferer. The method can further include storing the association in a memory. In some embodiments, the one or more machine learning algorithms are trained from one or more databases including at least stored information of interference classifications of interference signals.

In some embodiments, the interference classifications include at least one of frequency modulation (“FM”), chirp, orthogonal frequency division multiplexing (“OFDM”), narrowband, wideband, white noise, colored noise, or no interference. In some embodiments, the method can further include determining, for a transmission channel, a second potential interference signal; determining, using the one or more machine learning algorithms, the second potential interference signal is a second interference event; association, using the one or more machine learning algorithms, the second interference event with the interferer; and storing an indication that the interferer is transmitting persistent interference. In some embodiments, associating the second interference event with the interferer includes determining, using the one or more machine learning algorithms, the interference even to the second interference event are a first interference. In some embodiments, the method can further include rejecting, using the one or more machine learning algorithms, a set of transmission signals sent from the interferer. In some embodiments, the method can further include transmitting to one or more nodes of a mobile ad-hoc network (“MANET”) at least one of the interferer, the interference signal, or a determined class of the interference signal. In some embodiments, the interference signal includes a transmission frequency and transmission bandwidth.

Any of the features of any of the methods described herein can be used with any of the features of any of the other methods described herein. Any of the features of any of the systems, devices, or methods illustrated in the figures or described herein can be used with any of the features of any of the other systems, devices, or methods illustrated in the figures or described herein.

### BRIEF DESCRIPTION OF THE DRAWINGS

The drawings are provided to illustrate embodiments of the features described herein and not to limit the scope thereof.

FIG. 1 is a high-level illustration of components of example cognitive functionality of an example networking device.

FIG. 2A is a high-level illustration of an example cognitive engine for aiding in operation of an example networking device, such as referenced in FIG. 1.

FIG. 2B is a high-level illustration of another example cognitive engine for aiding in operation of an example networking device, such as referenced in FIG. 1.

FIG. 3 is an example process of updating operation of a networking device.

FIG. 4 depicts an example setup for demonstration of interference classification.

FIG. 5 illustrates narrowband, chirp, and pulsing jammer types of example interference classification.

FIG. 6 depicts example prediction accuracy by an example interference classification model described herein.

FIG. 7 depicts an example graphical user interface (GUI) representation for an example interference classification with tone jammers.

FIG. 8 is an example process of updating operation of a networking device based on interference signals.

FIG. 9 illustrates an embodiment of an example networking device including an antenna for receiving and transmitting data.

While the foregoing “Brief Description of the Drawings” references generally various embodiments of the disclosure, an artisan will recognize from the disclosure herein that such embodiments are not mutually exclusive. Rather, the artisan would recognize a myriad of combinations of some or all of such embodiments.

### DETAILED DESCRIPTION

Described herein are systems and methods for use with cognitive radio devices. The systems and methods described herein may or may not include and/or utilize networking devices or other devices (which may or may not be “cognitive” or “cognitive radios”) to perform some or all of the operations, techniques, and methods described herein.

### I. Cognitive Engine

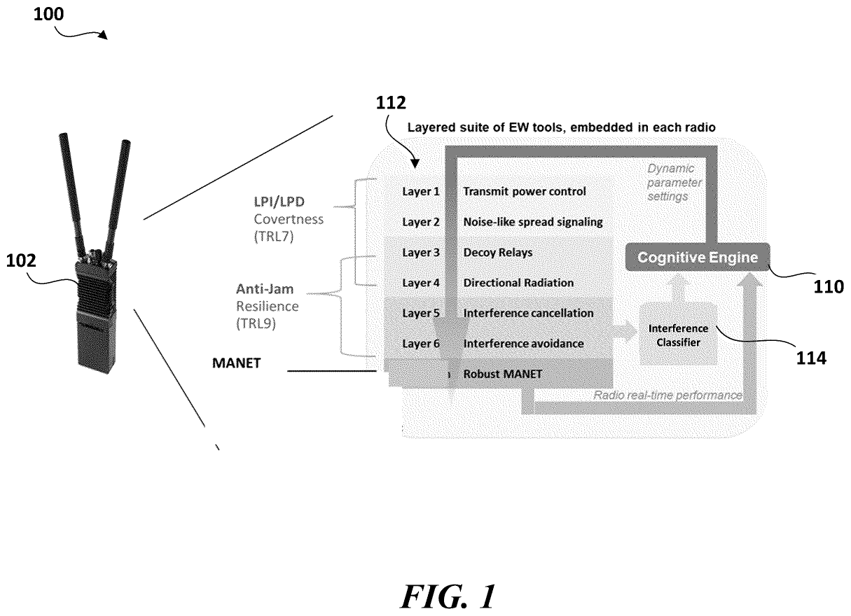

A cognitive engine may be used as part of a cognitive radio system 100. In some embodiments, the systems and methods described herein, such as a cognitive radio system 100, may employ a plurality of algorithms to provide robust and reliable communication in a wide range of congested and contested environments, including but not limited to adaptive or intelligence-based algorithms. In some embodiments, the cognitive radio system 100 may perform operations such as switching (autonomous or other), manipulation of operating modes, or other. In some embodiments, one or more of those operations may be performed based on information such as radio frequency (“RF”) sensing information, usage patterns, performance metrics, or other. Such cognition may enable switching, for example from a high-performance mode in an interference-free environment, to the “best” high-resilient mode when interference is detected. The networking devices achieve this goal by utilizing adaptive techniques to turn on, turn off, and adjust the operating parameters of a toolbox of algorithms working together, as depicted in FIG. 1.

According to various embodiments, a networking device, such as a cognitive radio system, may operate and/or update operation based on a set of operating configurations associated with the current operating environment. The operating configurations may define one or more of the operations described above. The networking device may communicate in a network with one or more other networking devices, such as radios, base stations, or other communication devices. During communication, the networking device may send and/or receive signal packets with other devices in the network. Between successful communications of the signal packets (e.g., between two consecutive communicated signal packets and/or after a failed signal packet), the networking device may identify transmission parameter data.

Transmission parameter data can include RF sensing information, whether interference is present or not, jammer-to-noise ratios (JNR), jammer bandwidths, signal-to noise rations (SNR) at the networking device, throughput at networking device, and/or other information associated with the operating environment of the networking device. The networking device can store the transmission parameter data in a memory on the networking device. For example, the networking device can store the transmission parameter data in a buffer in the memory. In some implementations, the networking device may continue to store transmission parameter data in the buffer until there is enough transmission parameter data in the buffer to make a determination (e.g., the buffer is full, or there is more than a threshold amount of data in the buffer). In some implementations, the buffer is continuously analyzed as new transmission parameter data is added.

The networking device may analyze the transmission parameter data by passing the transmission parameter data to a multilayer process to determine potential operating configurations. The multiplayer process may include two or more of the operation engines 112 illustrated in FIG. 1. In some embodiments, the operating configuration include one or more of a power operational setting (e.g., a power level of an input and/or output of the networking device), a frequency operational setting (e.g., a frequency of operating the networking device), a multiple-input multiple output operational setting (e.g., which and/or how many antennas on a transceiver to use), a time operational setting (e.g., time synchronization), or other operational settings for the networking device.

The networking device may arbitrate the potential operating configurations to determine a final set of operating configurations. In some embodiments, the networking device may utilize a cognitive engine, such as cognitive engine 110 of FIG. 1, to determine a final set of operating configurations. In some embodiments, the cognitive engine may include one or more machine learning models trained to optimize the operating configurations.

The networking device may be configured to identify an interference signal and update operation of the networking device based on the interference signal. As such, the networking device may quickly adapt to the presence of interference, which can be beneficial in environments with a high threshold of interference or even in response to deliberate interference, such as a jamming signal. The networking device can determine if the interference signal corresponds to a pretrained interference signal classifier known by the networking device (e.g., stored on the networking device or received from another source). The final set of operating configurations determined by the networking device may be based in part in an interference signal classifier that corresponds to the interference signal.

In some embodiments, the interference signal may be identified using the multilayer process, based on a covariance of multiple antennas of the networking device (e.g., when the networking device includes a multiple-input multiple-output (MIMO) radio), using other interference detection techniques, or any combination thereof. In some implementations, the cognitive engine may be used to determine if the interference signal corresponds to the pretrained interference signal classifier. If the interference signal does not correspond to an interference signal classifier known by the networking device, the interference signal may be stored in memory and used to inform (e.g., through training) one or more new interference signal classifiers known by the networking device.

FIG. 1 illustrates components of a networking device 102 for use in a cognitive radio system 100. In some embodiments, the networking device 102 operates as a node in a mobile ad-hoc network (“MANET”). In some embodiments, the networking device 102 may be a multiple-input multiple output (MIMO) radio. The networking device 102 can include a cognitive engine 110, operational engines 112, and one or more interference classifiers 114. The operational engines 112 can include processes used in transmission environments, such as signal processing algorithms for transmission and reception of radio signals. FIG. 1 depicts six operational engines 112 that can be utilized by a networking device: power control, noise-like signaling, decoy relays, directional radiation, interference cancellation, and interference avoidance. Although some descriptions herein may refer to this particular set of six operational engines 112, embodiments are not limited to these particular operational engines 112, and embodiments are also not limited to any specific number of operational engines 112 described herein. For example, fewer than six operational engines 112 may be employed and/or greater than six operational engines 112 may be employed by a cognitive radio system 100. Some or all of the techniques, operations, and methods described herein may use a different plurality of operational engines 112. In some embodiments, the plurality of operational engines 112 may include one or more of the six operational engines 112 described herein. In some embodiments, the plurality of operational engines 112 may include one or more operational engines 112 not included in the six operational engines 112 described herein. In a non-limiting example, the plurality of operational engines 112 may include a subset of the six operational engines 112 described herein. In another non-limiting example, the plurality of operational engines 112 may include a subset of the six operational engines 112 described herein, and one or more additional operational engines 112. In another non-limiting example, the plurality of operational engines 112 may not necessarily include any of the six operational engines 112 described herein.

Referring back to the six operational engines 112 depicted in FIG. 1, each operational engine 112 on its own may perform one or more individual functions. However, cognitive radio capabilities of the cognitive radio system 100 may be realized by one or more machine learning techniques, which may include intelligence, classification, learning, or other. In some embodiments, the machine learning technique(s) may guide, select, or control individual operational engines 112, the operation of the operational engines 112, parameters of the operational engines 112, parameters of a MANET, or other parameters (including, but not limited to bandwidth or modulation/coding). In some cases, a goal of the machine learning technique(s) is for the individual operational engines 112 or the network to work together toward a collective cognitive functionality. In this way, the machine learning technique(s) may arbitrate the output of the individual operation engines 112 to determine a final set of configuration settings for the networking device 102. It is also noted that, compared to solutions that only provide frequency translation as a means of defeating a jammer, the cognitive functionality of the cognitive radio system 100 described herein, realized by the depth and versatility of the toolbox of operational engines 112 shown in FIG. 1 (or other toolbox of operational engines 112), may enable connectivity in a variety of environments, including austere environments. In some embodiments, the layering of capabilities or operational engines 112 shown in FIG. 1 may provide multiple dimensions of covertness (prevent detection) and resilience (resist interference) to the networking device. Other layered configurations could focus on other dimensions of cognitive control by adding, removing, or replacing layers or operational engines 112. While FIG. 1 depicts operational engines 112 oriented in certain layers, orientations, or orders (e.g., the “transmit power control” operational engine is illustrated in “Layer 1”), the utilization of operational engines 112 can occur in any sequence. For example, the layers of operational engines 112 can begin at any of the operational engines 112 or two or more operational engines 112 may occur simultaneously.

In some embodiments, one or more layers of the operational engines 112 may operate in conjunction to form an overall feature. For example, FIG. 1 illustrates layers 1-4 as forming low probability of interference (“LPI”) and/or LPD features, which may influence the overall covertness of the networking device 102, and layers 3-6 as forming anti-jam features, which may influence the overall resilience of the networking device 102. However, these illustrations are not meant to be limiting and the operational engines 112 may form more or less than the features illustrated in FIG. 1. Further, the LPI, LPD, covertness, anti-jam, resilience, or other features illustrated in FIG. 1, may be controlled and/or influenced by operational engines 112 other than what is shown in FIG. 1.

In one example of an interaction of operational modes that may be impacted in a cognitive radio system 100, a high-performance operating mode of a device may be the desired mode of operation (as opposed to, for example, a high-resilient mode) when a harmless interference-free environment is sensed by the system. As a result, a feature like interference cancellation may be turned off (or disregarded) to avoid possible degraded performance in those situations. Other features, such as power control and spreading, may additionally or alternatively be relaxed to allow for maximum throughput and range.

A high-performance mode may also be realized by any of a plurality of possible configurations of operational engines 112 and/or parameters to use in the context of operation of the cognitive radio system 100. In the ongoing example of six operational engines 112, hundreds or more operational configurations can be used to accomplish a high-performance mode. Although the previous example notes interference cancellation (or interference mitigation) may be turned off in order to realize a desired high-performance mode, the scope of embodiments is not limited in this respect. For instance, one or more interference cancellation or other interference related operational engines 112 may still be turned on for a high-performance mode.

In some complex environmental situations, such as when interference is detected or sensed, a high-resilient operating mode of a device may be the desired mode of operation. A high-resilient mode may include a plurality of possible configurations of operational engines 112 and/or parameters to use in the context of operation of the cognitive radio system 100. In the ongoing example of six operational engines 112, hundreds or more operational configurations can be used to accomplish a high-resilient mode. This complexity is especially impacted due to operational trade-offs and/or interactions between operating engines and is thus not a straightforward selection of operational settings. For example, interference cancellation may be desired as part of the high-resilient mode. However, an optimal configuration of operational engines 112 may also include features like power control and noise-like signaling, which are both key enablers of low probability of detection (“LPD”) communication. Although the LPD communication itself does not directly combat jamming, it does indirectly provide a level of resilience. For example, if a jammer does not detect a networking device 102, then it will not jam the networking device 102 or infer the location of the networking device 102. Operating signal-to-noise ratio (“SNR”) and user desired throughput may be a factor when managing the primary two LPD enablers, power control may be sufficient when the operating range is low and SNR is abundant, while the noise-like signaling may be a better option when the operating range is long and throughput is secondary.

The trade-off between which LPD enabler to use (power control, noise-like signaling, or both) becomes even more complicated when the other operational engines 112 of the cognitive toolbox are also considered (like directional radiation and frequency translation). As complexity and functionality are added, the number of possible configurations can become so large that it is not feasible for a human to analyze them all and decide which strategies are to be used under which conditions. In addition, any attempted implementation would likely be cumbersome, difficult to program, error-prone, and impossible to understand and troubleshoot. Additionally, the time frame required to update settings must ideally keep up with the environmental conditions affecting the configuration choices. In examples where environmental conditions change in extremely short time frames (such as fractions of a second), human implemented selections for settings may not be sufficient to achieve the desired functionality of the cognitive radio system 100 and/or networking device 102. Instead, the cognitive radio systems and methods described herein may accomplish the goal of arbitrating the potential configuration settings to determine the best mode of communication based on the sensed RF environment with fewer possibilities for error and greater capacity to meet the needs of a user and/or cognitive radio system 100 in real time. The cognitive radio systems and methods described herein may utilize a robust machine learning process to accomplish all, or a part of this arbitration.

Advantageously, machine learning may help enable a selection of operational parameters and/or modes from an intractable number of possible high-resilient configurations. The machine learning algorithms may, in some examples, use a-priori human input of the value of various performance metrics (such as how much throughput is the user willing to sacrifice to obtain undetectability) and evaluate an enormous number of candidate configurations accordingly.

In another example, machine learning may help enable a discovery of indirect, complicated, or hidden relationships between the operational engines 112 of the cognitive toolbox. For instance, adding LPD functionality may make the networking device transmission less detectable, but may also lower throughput. Accordingly, the networking device transmission may need to be on-air longer, which may give an adversary (such as a frequency scanning jammer) a higher probability of detecting the networking device. The machine learning algorithms may parse these relationships between operational engines 112 and provide an optimized configuration for a specific circumstance.

In another example, machine learning may help maintain manageable implementations. Some machine learning techniques, including but not limited to convolutional neural networks (CNNs), may be efficient and generally stable, and may also provide manageable scalability when additional aspects are added (such as additional operational engines 112).

In some embodiments, the machine learning algorithms may be trained using interference simulations of various possible configurations of interference for the cognitive radio system. For example, the interference simulations may include multiple simulations of interferes and geographic distributions of cognitive radio system 100 in a transmission environment. The machine learning algorithms may be trained and/or retrained to determine an optimized configuration for the operational engines 112 in each of the interference simulations.

In some embodiments, the cognitive radio system 100 may operate as part of a cognitive MANET. As such, performance trade-offs in cognitive operation may become even more intricate and intractable in consideration of overall network metrics. For example, if one networking device 102 performs an LPD transmission to a peer networking device 102, the transmission may be on-air longer, increasing the probability of the peer networking device being jammed by an intermittent jammer, which in turn may increase the probability that the first networking device 102 must re-transmit, further lowering throughput, and so on. One challenge then is to achieve cooperation between cognitive engines of different cognitive radio systems 100 in a MANET with minimal data sharing overhead. To overcome this challenge, the nodes may communicate information between cognitive engines directly or indirectly. For example, the nodes may communicate indirectly through multi-hop mobile ad-hoc network (MANET) techniques and/or through communication to a cloud, server, networking, or the like. In a nonlimiting example, the MANET may be self-forming and/or self-healing, with hundreds or more nodes spread over hundreds of kilometers. Each node of the MANET may include, or form part of, adaptive routing features, modulation, coding, and/or a variable bandwidth (e.g., operating from 1.25-20 MHZ). The MANET may be suitable to adapt to many operating environments (e.g., urban environments, jungle environments, littoral environments, subterranean environments, and/or other operating environments).

In some embodiments, one or more techniques may be used to improve throughput, range, LPD, anti-jam (“AJ”), or other capabilities. For instance, multi-band operation and the ability to switch transmissions to an entirely new band may be used. In a non-limiting example, a target time for such switching may be 20 micro-seconds or similar. In some embodiments, one or more additional techniques may be used to improve those capabilities. In some cases, operational engines 112 are turned on and off manually and do not operate concurrently. One goal of the cognitive radio system 100 described herein is to change this with the introduction of a cognitive engine 110 to dynamically search for, learn, and access available spectrum resources as well as to optimally enable one or any combination of the operational engines 112 described herein. For instance, the optimization may be based on target performance criteria, such as LPD or AJ capabilities or other, in some embodiments.

In some cases, a benefit in network performance in a congested environment may be realized by the cognitive functionality of the cognitive radio system 100. For example, the cognitive engine 110 may utilize RF sensing mechanisms working in combination with various operational engines 112 for interference classification to learn about active interferers nearby. The output of the RF sensing mechanism may be used by the cognitive engine 110 via a machine learning classifier and the operational engines 112 in the previously described toolbox. Some embodiments may include various cognitive pieces to achieve the cognitive processing of the cognitive engine 110, such as learning, strategy, reasoning, rewards, and risks. In some embodiments, one or more of the cognitive engines 110 may output an interference classifier 114 and/or identify an interference signal. The interference classifier 114 and/or the identified interference signal may be used to determine and/or use a pretrained interference classifier (also referred to as a “threat classifier” or a “jammer classifier”). The pretrained interference classifier may be associated with a pretrained interference configuration (e.g., a known interferer, a known interference signal pattern, and/or other know interference configurations) and may be used by the cognitive engine 110 to determine a final set of operating configuration settings, a configuration of the operational engines 112, and/or otherwise used by the cognitive engine 110.

A brief description is provided for a plurality of operational engines 112. The descriptions provided herein are non-limiting and specifics of various operational engines 112 may be discussed for exemplary purposes.

### Power Control

In a non-limiting example, the nodes of a MANET exchange information (such as SNRs) and adjust the transmit power levels accordingly. One goal may be to deliver the required traffic between nodes of the MANET while collectively reducing the transmit power of each node so as to minimize the RF footprint of the entire MANET, thus improving the LPD characteristics for the entire MANET. In some embodiments, power control may operate on an entire mesh network, although the scope of embodiments is not limited in this respect. In some cases, power control may operate in a distributed minimum overhead manner.

In some embodiments, power control may include one or more devices, such as cognitive radio systems 100, reducing their transmit power. Reducing the transmit power may preserve battery life, improve LPD operation, reduce RF footprint, or otherwise alter the performance of a device. Power control may be performed between a pair of devices or between a plurality of devices (such as the nodes of a MANET). In a non-limiting example of power control between a first device and a second device, the first device transmits signals wirelessly to the second device, the second device measures one or more parameters, the second device communicates related information back to the first device, and the first device adjusts its transmit power at least partly based on the received information. Example parameter measurements include, but are not limited to, received power, signal strength, signal-to-noise ratio (“SNR”), and received signal strength indicator (“RSSI”). The information communicated by the second device may include or be based on one or more of the parameters measurements (such as an average) or may include an indication that the first device can lower its power. For instance, the first device may reduce its transmit power if the received SNR at the second device is stronger than necessary to maintain a target throughput or if the received SNR is above a threshold. The decision on whether to reduce the transmit power, or by how much, may be made by one or more of: the first device, the second device, another device, or a combination thereof.

### Noise-Like Spread Signaling

In a non-limiting example, a time domain signal may be scrambled in such a way as to reduce or eliminate spectral signatures. For example, usage of a uniform sub-carrier spacing in orthogonal frequency division multiplexing (“OFDM”) may result in a pattern in the frequency domain that is detectable by an adversary that is monitoring the spectrum. In this example, the time domain signal may be scrambled to reduce or eliminate such patterns. Further, if parameters of a signal like symbol period, frequency range, or other(s) are held constant, an adversary may be able to detect the presence of the signal. Therefore, varying such parameters in a manner known by each node of a MANET may reduce the detectability of the signal by the adversary.

In another non-limiting example, a signal may be spread in frequency. For instance, a signal that is limited to a frequency range of bandwidth B may be spread to occupy a bandwidth of N*B, where N may be a spreading factor or processing gain. If the transmit power between the spread and unspread signals is the same, then the power level of the spread signal appears to be lowered by a factor of N within the frequency range occupied by the unspread signal. Operational parameters used for spreading a signal may include, but are not limited to, the spreading factor, or a target transmit power.

### Decoy Relays

In a non-limiting example, LPD communication between nodes of a MANET may be realized via spoof transmissions by decoy devices working cooperatively with the MANET. Such spoof transmissions, and the overall decoy mechanism, can be realized in a variety of ways. In one example, while a desired communication between nodes is in process, one of the nodes of the MANET or another device (including but not limited to a device that is cooperative with the MANET) may transmit signals with a goal of distracting an adversary that is attempting to detect the desired communication.

### Directional Radiation

In a non-limiting example, directional transmission may be realized using techniques such as a directional antenna, steerable antenna, a multiple-input multiple-output (“MIMO”) radio, or other technique(s). For example, if multiple antennas transmit the same signal at approximately the same time, there is a directional radiation pattern that results. Techniques such as phase shifting, time delay, precoding or others may be used to control one or more parameters of that directional radiation pattern (such as direction, beamwidth, sidelobe level, level of splatter behind the beam, or other(s)). Operational parameters used to determine a directional radiation pattern may include, but are not limited to, a directional gain, a target level of sidelobe suppression, or a beamwidth (such as 3-dB beamwidth). In some cases, packet-by-packet transmit and receiver beamforming may be used.

### Interference Cancellation

In a non-limiting example, a receiver utilizes multiple antennas to mitigate interference, by dividing the signal space into orthogonal dimensions (a basis set). A variety of techniques may then be used to reduce the effects of interference on signal detection, based on projections of signal and interference into those dimensions. For instance, a technique that avoids utilizing dimensions with significant levels of interference projection may be used. In a non-limiting example, a receiving device (MIMO-enabled or otherwise) may use received signals to determine a received covariance matrix, which implicitly includes a contribution that depends on an interferer's channel to the receiving device. Using techniques like precoding, singular value decomposition, or other(s), a transmitting device may process a signal before it is transmitted to the receiving device, in a manner in which the process signal arrives at the receiving device orthogonal to the interference signal. Relevant operational parameters may include, but are not limited to, a threshold power level of interference, or a number of receive antennas.

### Interference Avoidance

In a non-limiting example, one or more receivers may (independently or otherwise) sense candidate channel(s) and/or band(s) to determine where to switch in case a receiver determines the presence of interference in its own channel and/or band. Within a network, these measurements are communicated among multiple nodes, which may enable the network to move to a better channel/band upon the onset of jamming. In a non-limiting example, a receiving device operating in a MANET may determine that there is interference present in its channel (or frequency band), which may cause a switch to a different channel (or frequency band). The switch may be performed by any or all of the receiving device, one or more other devices in the MANET, or the entire MANET. Relevant operational parameters may include, but are not limited to, a threshold power level of interference, a dwell time of the interferer, or duty cycle of the interferer.

### Cognitive Functionality of the Networking Device

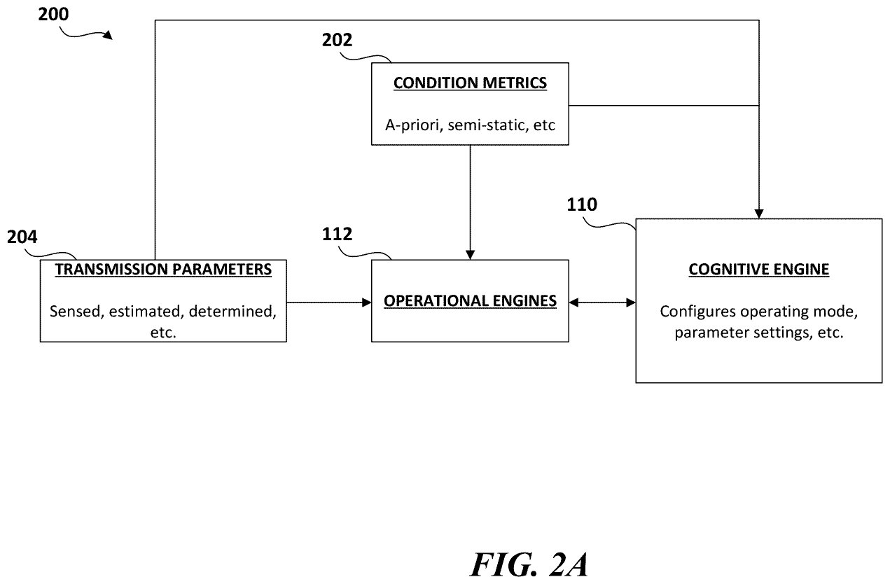

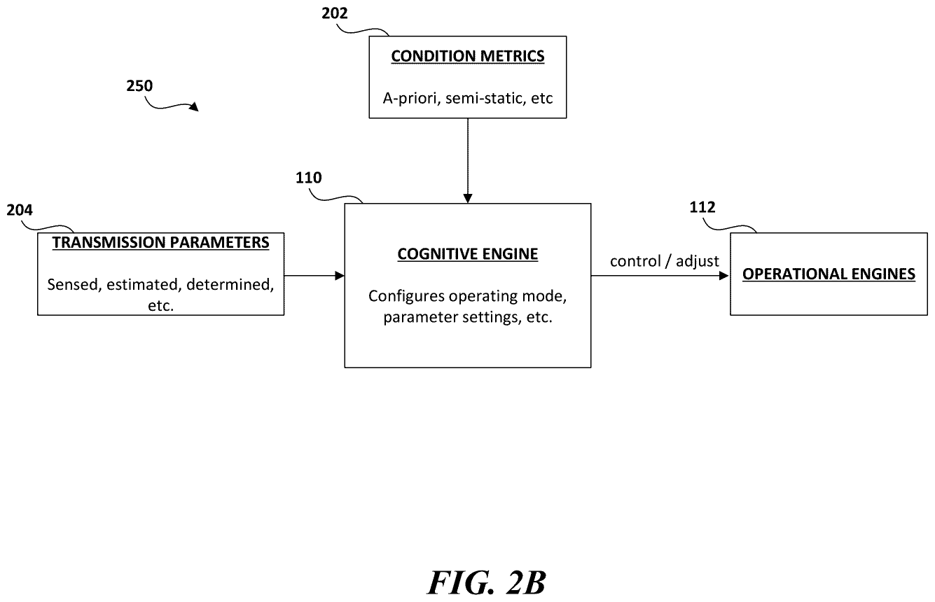

FIG. 2A illustrates a high-level block diagram 200 providing an example visualization of cognitive functionality for a networking device, such as networking device 102. FIG. 2B illustrates a high-level block diagram 250 providing another example visualization of cognitive functionality for a networking device, such as networking device 102. Embodiments are not limited to the arrangement, number, type, functionality, input/output, or other aspect of the blocks shown. Also of note, some of the techniques, operations, and methods described herein may or may not necessarily follow such a flow structure as that depicted in FIGS. 2A and 2B.

A networking device 102 can include a cognitive engine 110. In some embodiments, the cognitive engine 110 can make decisions about how to configure one or more operational engines 112 and/or arbitrate the output of operational engines 112 to determine configuration settings for the networking device 102. For example, the cognitive engine 110 may arbitrate a plurality of potential configuration settings provided to the cognitive engine 1100 to determine a final set of configuration settings for the networking device 102. As another example, the cognitive engine 110 can also enable or disable each of the operational engines 112 and/or adjust parameter values for each of the operational engines 112. In some embodiments, the operational engines 112 and the cognitive engine 110 may include feedback communications to the functionality of the operational engines 112 and/or the cognitive engine 110 to converge on an optimal final set of configuration settings from the networking device 102.

The cognitive engine 110 and/or the operational engines 112 may receive condition metrics 202 and transmission parameters 204 as inputs. The cognitive engine 110 can include machine learning algorithms to configure the networking device, as described in FIG. 1. The machine learning algorithms may be trained and/or re-trained using simulations of transmission environments. For example, simulations of various geographic locations of nodes in a MANET, different types and location of jammers, other types and sources of interference, and/or other parameters that may affect a transmission environment. In some embodiments, the machine learning algorithms can be trained using one or more of: simulation; analysis; computer-generated result/input combinations; randomly-generated result/input combinations; result/input combinations from lab experiments, field experiments, demonstrations, operation of a device (normal or experimental); or other machine learning training process. In some embodiments, additional training can be performed in response to one or more factors (including but not limited to those above). Various techniques may be used to incorporate the additional training, including but not limited to: automatically by a networking device 102, offline via updated software, in real-time, or other. In addition, the training process may include providing information or instructions or updated software to the networking device 102 via manual loading (such as by a human), updates from a cloud, server, network or other (including sending data there and retrieving data from it, or other.

The inputs used in the result/input combinations mentioned above may include time-domain signals; frequency-domain signals (such as an output of a Fourier transform operation applied to a time-domain signal); analog signals received at an antenna, an RF front end, or at another component; digital and/or discrete time signals received at an antenna, an RF front end, or at another component; parameter measurements (like SNR, noise floor, or other parameter measurements); prioritizations (such as which of LPD and throughput is more important); or other inputs. The results used in the result/input combinations mentioned above may include throughput, whether a device remains connected or not, amount of interference experienced by the device, or other results.

The cognitive engine 110 and/or the operational engines 112 can be utilized to perform the cognitive functionality of the cognitive radio system 100, as described herein, using machine learning algorithms. In some embodiments, the cognitive engine 110 runs continuously or at regular intervals in a networking device, such as networking device 102, to reconfigure the operational engines 112 based on real-time transmission conditions. In some embodiments, the cognitive engine 110 is activated based on a triggering condition. For example, the cognitive engine 110 may be activated in response to interference on a channel passing a threshold value, by user request, and/or other triggering condition. Advantageously, while activated, the cognitive engine 110 can analyze and respond to real-time transmission conditions. For example, the cognitive engine 110 can configure the operational engines 112 for LPD communication in real-time in response to sensing a jamming event. Such configurations of operational engines 112 can be configured repeatedly in response to changing transmission parameters 204 (e.g., multiple reconfigurations a second) and/or in response to changing condition metrics 202 (e.g., reconfiguring each time a condition metric is changed). Further detail of condition metrics 202 and transmission parameters 204 is provided below.

The cognitive engine 110 and/or the operational engines 112 can receive condition metrics 202 as input. The condition metrics 202 can inform the cognitive engine about the priorities for the networking device. For example, the condition metrics 202 can indicate that certain predetermined operating conditions, such as undetectability, throughput, quality of service, and connectivity, should have priority for the networking device 102. The condition metrics 202 can be indicative of what the networking device 102 (or a user of the networking device 102) considers important. For instance, a user of the networking device 102 may be in a high-alert tactical situation in which there is extreme value in undetectability. At other times, throughput may be the most important metric for that same networking device 102. The condition metrics 202 can be preconfigured and/or semi-static (for example, configurable, but changing infrequently). The condition metrics 202 may be ranked, determined, selected by user input, predefined and/or partially predefined.

The cognitive engine 110 and/or the operational engines 112 can receive transmission parameters 204, such as RF sensing information. For example, the transmission parameters 204 can include whether interference is present or not, jammer-to-noise ratios (JNR), jammer bandwidths, SNRs at the networking device 102, and/or throughput at the networking device 102. The transmission parameters 204 can change frequently, and the cognitive engine 110 can adjust accordingly. In some embodiments, the networking device 102 may receive and/or identify the transmission parameters 204 between successful communication of signal packets with other networking devices. For example, the networking device 102 may receive and/or identify the transmission parameters 204 between two consecutive communicated signal packets and/or after a failed signal packet.

The cognitive engine 110 can arbitrate the output of the one or more operational engine 112 and/or control and adjust one or more operational engines 112, as described above, based on the condition metrics 202 and the transmission parameters 204. For example, the cognitive engine 110 can utilize the condition metrics 202 and the transmission parameters 204 as input to one or more trained machine learning algorithms. The output of machine learning algorithms can be used to arbitrate the output of the one or more operational engine 112 and/or control and adjust the operational engines 112. For example, the cognitive engine can utilize the output of the machine learning algorithms to configure the operational engines 112 by enabling or disabling each of the operational engines 112 and by adjusting parameter values for each enabled operational engine. The operational engines 112 can include the six operational engines 112 described in FIG. 1, and/or any other operational engines 112.

The cognitive engine 110 can utilize the output of the machine learning algorithms to automatically configure the operational engines 112. In some embodiments, the cognitive engine 110 utilizes the output of the machine learning algorithm to suggest to a user a configuration for the operational engines 112. In some embodiments, the cognitive engine 110 utilizes a combination of automatic configuration of operational engines 112 and a suggestion to a user of a configuration for the operational engines 112. For example, the cognitive engine 110 can automatically reconfigure operational engines 112 in most scenarios but require user confirmation under particular circumstances, such as if the reconfiguration will result in the loss of critical functionality of the networking device. In some embodiments, a user of the networking device can override the configuration of the operational engines 112. For example, a user may override an LPD configuration to increase throughput.

When a cognitive engine 110 is asked to solve a problem (e.g., detected interference, high SNR, etc.), the cognitive engine 110 may utilize condition metrics 202 and transmission parameters 204 to generate, control, and/or adjustment parameters to utilize with one or more operational engines 112, such as described herein. The condition metrics 202 indicate the priorities of the networking device 102. For example, condition metrics 202 can be ranked from highest to lowest as: undetectability, followed by continuous connectivity, followed by throughput; the transmission parameters include a measured relatively high SNR with no interference is detected. Given the ranking, the cognitive engine 110 may utilize machine learning algorithms to determine which of the one or more operational engines 112 should be used, and what individual parameter values should be used for each of the utilized operational engines 112. Thus, the cognitive engine 110 can determine an optimized configuration from thousands of possible configurations.

### II. Example Process

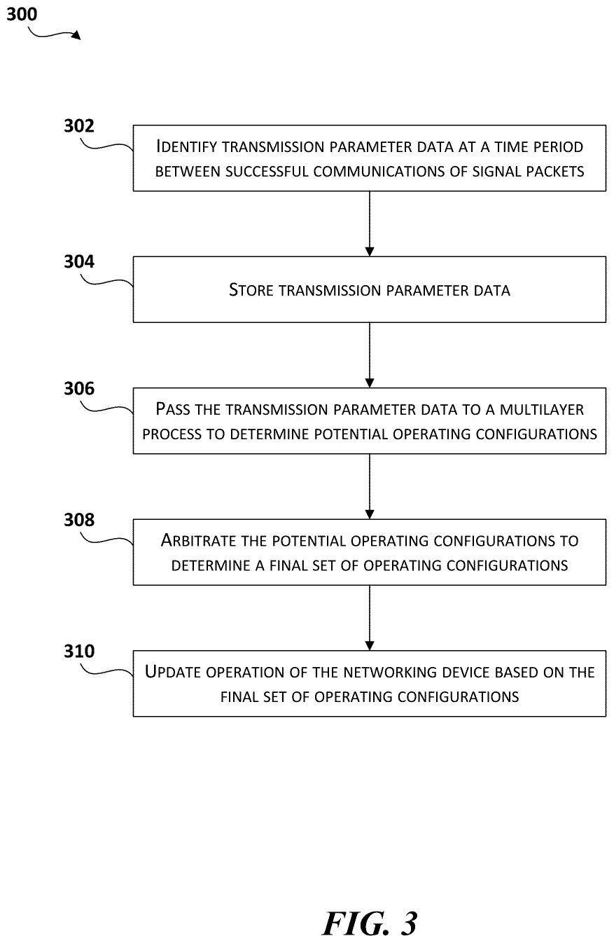

FIG. 3 illustrates an example process 300 of updating operation of a networking device. In some embodiments, process 300 may be implemented by networking device, such as networking device 102, in a cognitive radio system 100. At block 302, the networking device identifies transmission parameter data at a time period between successful communications of signal packets. During communication, the radio may send and/or receive signal packets with other devices in the network. In various embodiments, the time period between successful communications of signal packets may be after two consecutive communicated signal packets and/or after a failed signal packet. The transmission parameter data can include RF sensing information, whether interference is present or not, jammer-to-noise ratios (JNR), jammer bandwidths, signal-to noise rations (SNR) at the networking device, throughput at networking device, and/or other information associated with the operating environment of the networking device.

At block 304, the networking device stores the transmission parameter data in a memory on the networking device. For example, the networking device can store the transmission parameter data in a buffer in the memory. In some implementations, the networking device may continue to perform block 304 until there is enough transmission parameter data in the buffer to make a determination (e.g., the buffer is full, or there is more than a threshold amount of data in the buffer). In some implementations, process 300 continues to block 306 each time transmission parameter data is stored in the buffer.

At block 306, the networking device passes the transmission parameter data to a multilayer process to determine potential operating configurations. The multiplayer process may include two or more of the operation engines 112 illustrated in FIG. 1. In some embodiments, the operating configuration include one or more of a power operational setting (e.g., a power level of an input and/or output of the networking device), a frequency operational setting (e.g., a frequency of operating the networking device), a multiple-input multiple output operational setting (e.g., which and/or how many antennas on a transceiver to use), a time operational setting (e.g., time synchronization), or other operational settings for the networking device. The potential operating configurations may be associated with a generalized operation mode (e.g., a “high-resilient mode”). The potential operating configurations may include many possible configurations for the networking device (e.g., tens, hundreds, thousands, or more potential operating configurations). In some embodiments, the multilayer process is used to determine current performance information associated with the networking device that can be used with a classifier to determine at least one dynamic parameter setting.

At block 308, the networking device arbitrates the potential operating configurations to determine a final set of operating configurations. In some embodiments, the networking device may utilize a cognitive engine, such as cognitive engine 110 of FIG. 1, to determine a final set of operating configurations. In some embodiments, the cognitive engine may include one or more machine learning models trained to optimize the operating configurations. The cognitive engine and/or one or more of the machine learning models may utilize at least one classifier stored in a memory to determine a dynamic parameter setting in the final set of operating configurations.

At block 310, the networking device updates operation of the networking device based on the final set of operating configurations. In some embodiments, process 300 allows the networking device to adjust operation based on real-time performance of the networking device.

### III. Interference Classification

In some embodiments, systems and methods described herein may include interference classification. Interference classification may benefit a cognitive radio system described herein, such as cognitive radio system 100. Interference classification may utilize machine learning to detect and/or classify interference. In a non-limiting example, an interference classification algorithm may analyze an input signal and determine which class of interference it belongs to, from a predetermined plurality of interference classes (which may also include a “no interference present” type of class). Example classes include FM, chirp, OFDM, narrowband, wideband, white noise, colored noise, or other. In the non-limiting example, a time-domain signal (analog or digital) may be processed by a Fourier transform (such as fast Fourier transform (“FFT”) or other Fourier transform) to produce frequency-domain results that are input to the interference classification algorithm. Accordingly, the algorithm may be trained by a similar process in which many different signals (with types known) are generated by lab equipment, generated by other devices, simulated, or otherwise collected, and then processed by a Fourier transform. One such pair (the frequency-domain results, plus the known type) may be considered a “labeled example.” Multiple labeled examples are used to train a machine learning algorithm such as a neural network or other machine learning algorithm. Other training techniques used in training machine learning algorithms mentioned herein, in whole or in part, may be used in addition to or instead of the above. For instance, labeled examples may be collected on a server and retrieved by a device in order to train the device.

In some embodiments, a machine learning algorithm for interference classification can be trained using one or more of: simulation; analysis; computer-generated result/input combinations; randomly-generated result/input combinations; result/input combinations from lab experiments, field experiments, demonstrations, operation of a device (normal or experimental); or other machine learning training process. In some embodiments, additional training can be performed in response to one or more factors (including but not limited to those above). Various techniques may be used to incorporate the additional training, including but not limited to: automatically by a device, offline via updated software, in real-time, or other. In addition, the training process may include providing information or instructions or updated software to the device via manual loading (such as by a human), updates from a cloud, server, network or other (including sending data there and retrieving data from it.

The inputs used in the result/input combinations mentioned above may include but are not limited to time-domain signals; frequency-domain signals (such as an output of a Fourier transform operation applied to a time-domain signal); analog signals received at an antenna, an RF front end, or at another component; digital and/or discrete time signals received at an antenna, an RF front end, or at another component; or other inputs. The results used in the result/input combinations mentioned above may include a signal type (such as FM, chirp, frequency hopping, or other), one or more signal parameters (bandwidth, power, hop rate, duty cycle, or other), or other results.

In some embodiments, the interference classification algorithm may determine that an interference is “persistent.” For instance, the interference classification algorithm may detect interference, and may determine that this interference was detected previously (in contrast to deciding that the interference is from a fresh, new source). It is possible for the device to utilize this information in a beneficial manner. For example, if an interference rejection algorithm is trained to reject interference from this particular source, the trained algorithm can continue to be used whenever this interference source is identified, as opposed to beginning a training process every time any interference is detected. Another benefit may be realized in a MANET if nodes inform each other of detected interference, and then compare notes with each other. For instance, if two nearby nodes of the MANET both determine FM interference of approximately the same bandwidth and same frequency, they may conclude that they are both detecting the same interference source. Also, it may be possible for a node of the MANET to detect a strong interferer at a particular frequency, and then to alert other nearby nodes about the possibility that they might experience interference from the same interferer, and provide information about the detected interference (bandwidth, frequency, or other) to assist those other nodes in their own interference-related algorithms (classification, mitigation, cancellation, avoidance, or other).

For example, operational engines 112 such as interference cancellation may benefit from knowledge of the type of interference and other parameters of it, allowing various settings in the operational engines 112 to be tuned accordingly, to maximize performance. In another example, by tracking of a persistent interferer—the cognitive radio system 100 may see the same interferer repeatedly. In such a circumstance, it may be helpful for the cognitive radio system 100 to be able to determine, when interference is detected, whether it is a new interferer, or the same interferer already detected. In another example, identification of an interferer may occur in multiple nodes of a MANET. The nodes may communicate information to each other about the detected interferers and determine that each of the multiple nodes are seeing the same interferer and can adjust their communication collectively in response.

In some cases, an interference classification feature may enable detection and classification of jammer signals in real-time (although off-line or a combination of real-time and off-line techniques are possible, in some embodiments). By providing information for environments that require cognitively adaptive operations (for example, in electronic warfare (“EW”) operations), this feature may improve communication resilience and efficiency in some cases.

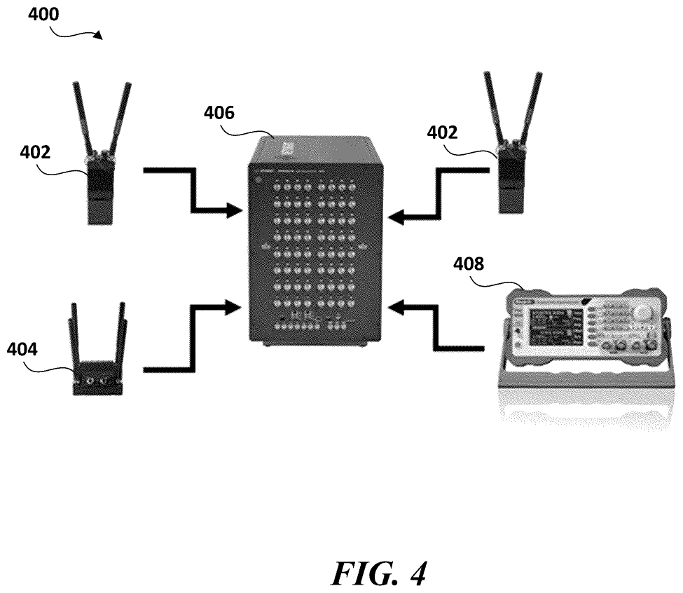

FIG. 4 depicts an example setup for demonstration of interference classification. The setup of FIG. 4 can be used to generate training sets used to train machine learning to detect and/or classify interference. The scope of embodiments is not limited by the demonstration depicted in FIG. 4 and is also not limited by the components shown in terms of number, type, arrangement, or other aspect. In this example, a three-node network 400 may include a data collection node 404 and two transmission nodes 402. The data collection node 404 may utilize the systems and devices for transmission described herein, such as the cognitive radio system 100 and/or the networking device 102. The network 400 may utilize a signal generator 408 to produce a variety of interference types, mimicking jammer signals to be used for AI model training. The network 400 may utilize a network emulator 406 to create a fully connected network with MIMO channels, providing a controlled environment for high-quality training data generation. In addition to the test conducted by the network emulator 406, over-the-air testing may be conducted to ensure the reliability and accuracy of the data collected.

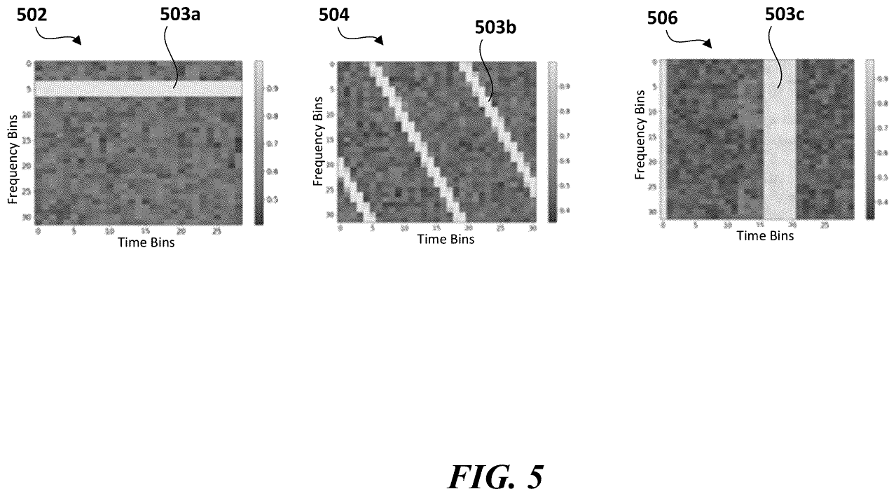

Once the data is captured, feature engineering may be performed to prepare, preprocess, and transform the data into an appropriate format for the training phase. In FIG. 5, a modified spectrogram presents the captured I/Q signal in a time-frequency normalized image format, which may illustrate features to classify and parameterize the jammers for use in the training phase. In FIG. 5, narrowband jammer 502, chirp jammer 504, and pulsing jammer 506 in a high-JNR regime are illustrated for understanding. Each of the narrowband jammer 502, chirp jammer 504, and pulsing jammer 506 are illustrated with interference signals 503a-503c, respectively. Using this prepared data, an offline machine learning model may be trained to recognize patterns associated with various jammer signals and their parameters, such as center frequency, Jammer to Noise Ratio (“JNR”), and bandwidth for wideband signals and center frequency and JNR for narrowband signals.

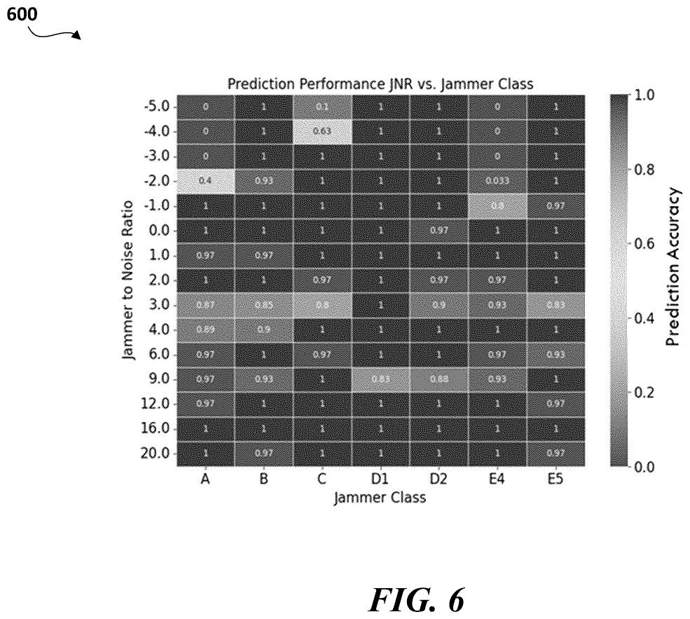

In a non-limiting example, an AI model may be deployed across a network of networking devices, and each node may run the classifier in real-time while maintaining normal network operation. In some cases, a graphical user interface (“GUI”) may display live (or off-line) classification results, providing users with information on jammer signal parameters, such as center frequency, JNR, and bandwidth for wideband signals and center frequency and JNR for narrowband signals. The results illustrated in table 600 of FIG. 6 demonstrate a non-limiting example of prediction accuracy for various jammer types, which are characterized according to jammer class and JNR.

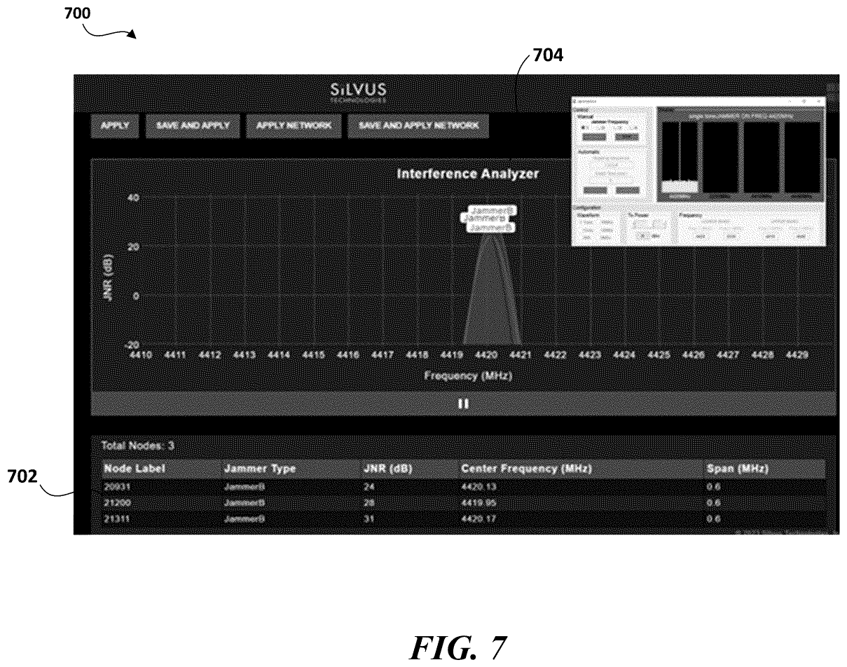

FIG. 7 provides an example GUI 700 depicting the identification of tone jammers. GUI 700 may illustrate the presence of one or more interference signals (jammers). As illustrated in FIG. 7, GUI 700 can include a table 702 that summarized the interference signals as seen by nodes of the network (e.g., nodes of a MANET). The table 702 can include identification of the node that identified an interference signal, an identification of a jammer type, an indication of JNR associated with the interference signal, a center frequency of the interference signal, and a pan of the interference signal. In some embodiments, the jammer type may be identified using one or more pretrained interference signal classifiers, as described herein. Information may also be displayed graphically in graph 704. For example, graph 704 may display a graphical representation of at least a portion of the information contained in table 702. In some embodiments, graph 704 may contain information not contained in table 702.

In some embodiments, interference classification may have additional capabilities. For example, interference classification may further include determining and/or classifying a number of simultaneous interferers, determining types of interferers, or other capabilities. Interference classification may increase the performance and resilience of wireless devices, such as the networking device described herein, in challenging environments by using one or more techniques described herein. In some embodiments, the interference classification may detect and classify jammer signals in real-time. In some cases, as a result, users may have information to enable cognitive adaptive EW operation, ensuring reliable and efficient communication even in the face of complex interference.

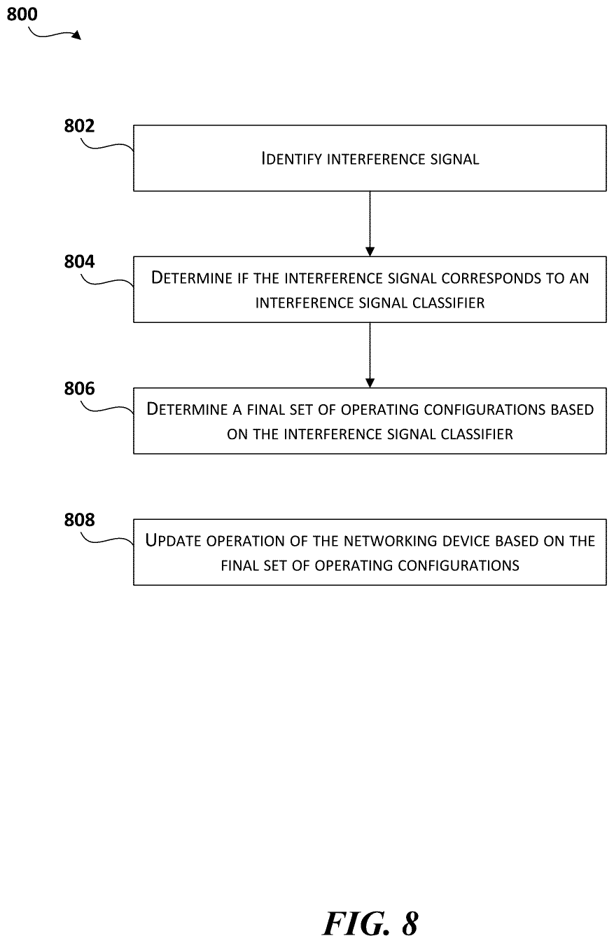

FIG. 8 illustrates an example process 300 of updating operation of a networking device based on interference signals. In some embodiments, process 300 may be implemented by networking device, such as networking device 102, in a cognitive radio system 100. As such, the networking device may quickly adapt to the presence of interference, which can be beneficial in environments with a high threshold of interference or even in response to deliberate interference, such as a jamming signal.

At block 802, the networking device identifies an interference signal. For example, networking device may identify the interference signal by using the multilayer process, based on a covariance of multiple antennas of the networking device, using other interference detection techniques, or any combination thereof.

At block 804, the networking device determines if the interference signal corresponds to an interference signal classifier. The interference signal classifier may be one of a plurality of pretrained interference signal classifiers. The pretrained interference signal classifiers may be identified and/or trained using the techniques described above and stored in a memory of the networking device. In some embodiments, the interference signal classifier is based on one or more previously received interference signals used to train the interference signal classifier. If the networking device determines that the interference signal does not correspond to an interference signal classifier, the networking device may store the interference signal to be used to determine a new interference signal classifier.

At block 806, the networking device determines a final set of operating configurations based on the interference signal classifier. For example, the networking device may utilize the interference signal classifier as input to a cognitive engine and/or one or more machine learning models. The cognitive engine and/or one or more machine learning models may output the final set of operating configurations. In some embodiments, process 800 can be performed with process 300. As such, the final set of operating configurations may be based on both the interference signal classifier and the potential configuration settings.

At block 3808, the networking device updates operation of the networking device based on the final set of operating configurations. In some embodiments, process 800 allows the networking device to adjust operation based on real-time interference at the networking device.

### IV. Example Networking Device

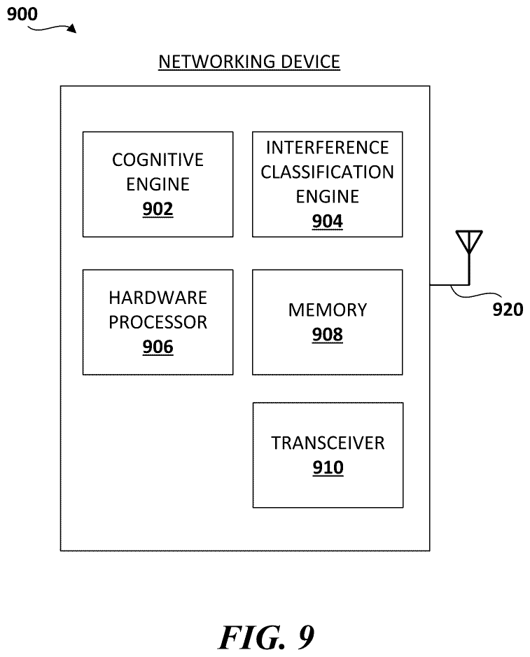

FIG. 9 illustrates an embodiment of a networking device 900 including a transceiver 910 and an antenna 920. The networking device 900 can include any of the functionality of the cognitive radio system 100 described above. The Networking device 900 can form one of the nodes of a MANET. In some embodiments, the networking device 900 can also be a part of a network that includes a centralized hub. The networking device 900 may include legacy radio devices. In some embodiments, the networking device 900 is a Rifleman Radio. In other embodiments, the networking device 900 is a radio that implements one or more of the Institute of Electrical and Electronics Engineers' (IEEE) 802.11 standards, such as, for example a “Wi-Fi” radio. A networking device that implements one or more such IEEE 802.11 standards will be referred to herein as a radio, system, protocol, or technology that has “WiFi.” The networking device 900 can include a radio that uses Soldier Radio Waveform (SRW).

The networking device 900 includes a transceiver 910 for transmitting and/or receiving signals. In some embodiments, the networking device 900 can include more than one transceiver (not shown). For example, the networking device 900 may have separate transceivers for receiving and transmitting signals. In some embodiments, the networking device 900 can be a MIMO networking device. The embodiments of cognitive engine and interference implementation described herein can be used by the networking device 900 with any additional cognitive radio system 100 to communicate over a shared medium.

In some embodiments, the networking device 900 may utilize RF sensing, and embodiments are not limited to any particular technique. In some embodiments, RF sensing (by itself or in combination with one or more other algorithms) may detect and geo-locate (range and angle) one or more RF emitters (including multiple RF emitters simultaneously). Non-limiting examples of RF emitters include network emitters and pulsing emitters. The frequency range is not limited to any particular range. In one non-limiting example, a range of multi-GHz of spectrum may be used. In addition, different hardware configurations are possible, including but not limited to a single board sensor that can be married with a networking device 900. In some cases, the RF sensing may produce RF awareness, signal intelligence (SIGINT), and/or other.

The networking device 900 can include hardware and/or software modules. In the illustrated embodiment, the networking device 900 includes a hardware processor 906 and a memory 908. The memory 908 can include one or more databases, cloud storage databases, and/or the like for storing data and computer readable instructions. Further, the networking device 900 includes a cognitive engine module 902 and an interference classification engine module 904. The cognitive engine module 902 and the classification engine module 904 may be implemented in hardware or software or a combination of both. In some embodiments, the hardware processor 906 may execute the cognitive engine module 902 and the classification engine module 904. Further, in some embodiments, the memory 908 can include instructions corresponding to the cognitive engine module 902 and the classification engine module 904. For example, the memory 908 can store commands for operation of the networking device 900, such commands may include commands to change its channel, sense interference, control cognitive engines, classify interference, and/or any other functionality of a networking device described herein. The memory 908 can also store parameters for the cognitive engines, the multilayer processes, interference classifiers, identities of detected interferers, and the like. The networking device 900 may also include additional modules not shown in the illustrated embodiment. For example, the networking device 900 may include a power source such as a battery.

The interference classification engine module 904 can implement the functionalities of the interference classification described herein. The cognitive engine module 902 can implement the functionalities of the cognitive engine described herein. The cognitive engine module 902 can work in conjunction with the interference classification engine module 904 to provide robust and reliable communication in a wide range of congested and contested environments.

In some embodiments, the cognitive engine module 902 can work in conjunction with the interference classification engine module 904 can work in conjunction to identify and classify interference, derive network restoration strategy, and implement network restoration response. In a non-limiting example, interference classification performed by the interference classification engine module 904 may include classifying two or more different interference types. In some embodiments, a “no interference” case may be included. Interference classification may use one or more of: machine learning, AI, dynamic spectrum access (DSA), Network Function Virtualization (NFV) and Software-Defined Networking (SDN). Network restoration may be realized by usage of various self-healing techniques or other.

In some embodiments, the networking device 900 may realize a capability to learn. In a non-limiting example, this capability may include a cohesive ability to recognize, retain, and cogitate previous interference responses/strategies to better classify interference and reduce cognitive radio processor requirements. Some embodiments may include techniques to create and store use cases, profiles, knowledge, and corresponding strategies for cognitive functionality and interference scenarios in memory 908. For instance, interference measurements collected in an environment over time, along with responses from the cognitive engine (like which of the operational engines 112 to use, and which parameter values to set) may be stored in memory 908, and used as part of training for machine learning algorithms (like CNNs). Such information (use cases, profiles, knowledge, strategies, etc.) may also utilize cloud storage, and/or may take advantage of the MANET functionality of the networking device for communication of such information between nodes. In some embodiments, some or all of the processes described herein can be performed in a laboratory and stored in memory 908 and used for training and/or re-training of the machine learning algorithms of the cognitive engine module 902 and/or the interference classification engine module 904. Examples include partial re-training of only a few layers of a neural network; cloud-based customer-oriented retraining; or a quick-turnaround laboratory setup for retraining based on data relevant to a deployment or use case. Such techniques may be based on one or more of machine learning, AI, deep learning, transfer learning, edge computing, hardware accelerators, data compression, feature extraction, or other.

Some embodiments of networking device 900 may include intra-node communication between MANET nodes to communicate information (including but not limited to some or all of the above information) and/or retrieve such information from cloud-based storage. Some embodiments may include one or more of FPGA-based reconfigurability, SDR-driven flexibility, AI for intelligent decision making, and jamming attack mitigation.

Some embodiments of networking device 900 described herein may enable or utilize reasoning. In a non-limiting example, such reasoning may include network inference of countermeasure strategies from actions previously taken and existing measurements (for instance, real-time analysis of EMS, network, radio telemetry, or other).

In addition, some embodiments of networking device 900 described herein may use a link adaptation protocol. In a non-limiting example, such a protocol may increase (automatically or otherwise) throughput as the signal to-jammer-noise ratio is reduced and may decrease throughput as the jammer intensity increases.

### V Example Machine Learning Algorithms

In accordance with several embodiments, one or more steps of the processes described herein can be performed using machine learning techniques (e.g., using a trained artificial neural network that involves deep learning algorithms). The machine learning or deep learning algorithms may be trained by a controller using supervised or unsupervised training. The processes disclosed herein can employ machine learning modeling along with signal processing techniques to analyze signals to configure operational engines and/or perform interference identification, such as discussed above. Use of machine learning may advantageously increase reliability or accuracy of functionality, such as predictions and reduce false positive predictions based on human error. In accordance with several embodiments, by applying machine learning algorithms to large quantities of data associated with received signals, reliably accurate and extremely quick identification of interferers and/or operational engine configurations may be possible.

Machine learning modeling and signal processing techniques include but are not limited to supervised and unsupervised algorithms for regression and classification. Specific classes of algorithms include, for example, Artificial Neural Networks (Perceptron, Back-Propagation, Convolutional Neural Networks (e.g., fast-region convolutional neural networks), Recurrent Neural networks, Long Short-Term Memory Networks, Deep Belief Networks), Bayesian (Naive Bayes, Multinomial Bayes and Bayesian Networks), clustering (k-means, Expectation Maximization and Hierarchical Clustering), ensemble methods (Classification and Regression Tree variants and Boosting), single or multiple linear regression, wavelet analysis, fast Fourier transforms, instance-based (k-Nearest Neighbor, Self-Organizing Maps and Support Vector Machines), regularization (Elastic Net, Ridge Regression and Least Absolute Shrinkage Selection Operator), and dimensionality reduction (Principal Component Analysis variants, Multidimensional Scaling, Discriminant Analysis variants and Factor Analysis). In some embodiments, any number of the foregoing algorithms are not included. Neural networks may be trained, stored, and implemented on modules such as described herein, including but not limited to the cognitive engine and interference classification engine modules described above.

Machine learning techniques may include, for example, training a neural network for use and then using the neural network in performing one or more of the steps of the processes described herein (e.g., performing interference classification and configuring cognitive). The neural network may be trained and/or re-trained using laboratory simulations of transmission environments, large sets of transmission data, and the like. The data may be from databases of stored data accessible over a network.

The training may involve applying pre-processing techniques to the transmission data to facilitate feature extraction or detection. In some embodiments, the pre-processing may be targeted to only portions of the data that are deemed to be of interest (e.g., portions of the transmission data likely to exhibit indicators interference). In accordance with several embodiments, if pre-processing is not performed on the data, the output may be less accurate due to poor data quality that results in less-than-ideal feature extraction or detection. However, pre-processing many not always be necessitated.

Training may further include performing automated feature extraction, or detection, techniques. Training may involve performing detection tasks to recognize transmission scenarios and/or classify interference. In some embodiments, feature extraction or detection may be partially or completely performed manually by one or more users (e.g., user inputting known interference signals, user set up transmission environments for simulation, etc. using a user interface or user input tool). In some embodiments, training data may be provided with annotation data or tags (e.g., in a comma-separated values (CSV) file) with information about the state of the transmission environment, location of interferers, number of nodes in a MANET, location of nodes in a MANET, type of interference signal, ideal configuration of operational engines, etc.

An unsupervised neural network may be used to identify patterns to classify or extract features. For example, the neural network may involve use of classification algorithms that include clustering (k-means, Expectation Maximization and Hierarchical Clustering), ensemble methods (Classification and Regression Tree variants and Boosting), instance-based (k-Nearest Neighbor, Self-Organizing Maps and Support Vector Machines), regularization (Elastic Net, Ridge Regression and Least Absolute Shrinkage Selection Operator), and dimensionality reduction (Principal Component Analysis variants, Multidimensional Scaling, Discriminant Analysis variants and Factor Analysis) to classify or extract features that may correlate to indicators of transmission environments, interference, type of interference, identity of interferer, etc.

### VI. Additional Considerations

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by one or more hardware processors, such as microprocessor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. Hardware processors can include electrical circuitry configured to process computer-executable instructions. In another embodiment, a hardware processor includes an FPGA or other programmable device that performs logic operations without processing computer-executable instructions. A hardware processor can also be implemented as a combination of computing devices, e.g., a combination of a DSP and a microprocessor, a plurality of microprocessors, one or more microprocessors in conjunction with a DSP core, or any other such configuration. A computing environment can include any type of computer system, including, but not limited to, a computer system based on a microprocessor, a mainframe computer, a digital signal processor, a portable computing device, a device controller, or a computational engine within an appliance, to name a few.

The steps of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An example storage medium can be coupled to the hardware processor such that the hardware processor can read information from, and write information to, the storage medium. In the alternative, the storage medium can be integral to the hardware processor. The storage medium can be volatile or nonvolatile.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

While the above detailed description has shown, described, and pointed out novel features as applied to various embodiments, it will be understood that various omissions, substitutions, and changes in the form and details of the systems, devices or methods illustrated can be made without departing from the spirit of the disclosure. As will be recognized, certain embodiments described herein can be embodied within a form that does not provide all of the features and benefits set forth herein, as some features can be used or practiced separately from others.

The term “and/or” herein has its broadest, least limiting meaning which is the disclosure includes A alone, B alone, both A and B together, or A or B alternatively, but does not require both A and B or require one of A or one of B. As used herein, the phrase “at least one of” A, B, “and” C should be construed to mean a logical A or B or C, using a non-exclusive logical or.

The apparatuses, systems, and/or methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Although the foregoing disclosure has been described in terms of certain preferred embodiments, other embodiments will be apparent to those of ordinary skill in the art from the disclosure herein. Additionally, other combinations, omissions, substitutions and modifications will be apparent to the skilled artisan in view of the disclosure herein. Accordingly, the present invention is not intended to be limited by the description of the preferred embodiments, but is to be defined by reference to claims.

### VII. Examples

Disclosed herein are additional examples of systems and methods described herein. Any of the examples in this disclosure may be combined in whole or in part. Any of the systems described in the examples may implement any of the methods, processes, and/or the like described herein and any of the methods described in the examples may be implemented by any of the systems described herein. Some aspects of the embodiments discussed above are disclosed in further detail in the additional examples, which are not in any way intended to limit the scope of the present disclosure. Those in the art will appreciate that many other embodiments also fall within the scope of the invention, as it is described herein above and in the claims. Any of the examples may include fewer or greater components or steps. Further, components and/or method steps described in the examples can be replaced with other components and/or method steps.

Example 1. A radio comprising: a transceiver configured to communicate signal packets; a memory configured to store a multilayer process; and one or more hardware processors in communication with the memory and configured to: identify transmission parameter data at a time period between successful communications of the signal packets; store the transmission parameter data in a buffer in the memory; pass the transmission parameter data to the multilayer process to determine a plurality of potential operating configurations comprising at least one of a power operational setting, a frequency operational setting, a multiple-input multiple-output operational setting, or a time operational setting; arbitrate the plurality of potential operating configurations to determine a final set of operating configurations; and update operation of the radio based on the final set of operating configurations.

Example 2. The radio of Example 1, wherein the transceiver is configured to communicate the signal packets with different multiple-input multiple-output (“MIMO”) radios of a mobile ad-hoc network (MANET).

Example 3. The radio of Example 1, wherein the transmission parameter data is identified after a failed data packet.

Example 4. The radio of Example 1, wherein the one or more hardware processors are configured to pass the transmission parameter data to the multilayer process when the buffer is full.

Example 5. The radio of Example 1, wherein the one or more hardware processors are configured to continuously pass the transmission parameter data to the multilayer process.

Example 6. The radio of Example 1, wherein the memory is further configured to store one or more machine learning algorithms, and wherein the one or more hardware processors are configured to arbitrate the plurality of potential operating configurations to determine the final set of operating configurations using at least one machine learning algorithm of the one or more machine learning algorithms.

Example 7. The radio of Example 6, wherein the at least one machine learning algorithm of the one or more machine learning algorithms is trained using stored information of interference simulations.

Example 8. The radio of Example 7, wherein the interference simulations include multiple configurations of interferes and geographic distributions of a plurality radios.

Example 9. The radio of Example 7, wherein the one or more machine learning algorithms are further trained or re-trained using interference measurements collected in an environment over time.

Example 10. The radio of Example 1, wherein the transmission parameter data comprises at least one of signal-to-noise ratio at the radio, detection of interference, jammer-to-noise ratio, jammer bandwidth, or throughput at the radio.

Example 11. The radio of Example 1, wherein the multilayer process comprises two or more of a transmit power control engine, a noise-like spread signaling engine, a decoy relays engine, a directional radiation engine, an interference cancellation engine, or an interference avoidance engine.

Example 12. The radio of Example 1, wherein the transceiver is configured for multiple-input multiple output (“MIMO) communication, and wherein the one or more hardware processors are further configured to manipulate interference cancellation through processing information from multiple receive antennas of the transceiver.

Example 13. The radio of Example 1, wherein the one or more hardware processors are further configured to: receive a user defined condition metric associated with one or more predetermined operating conditions for the radio; and arbitrate the plurality of potential operating configurations and the user defined condition metric to determine the final set of operating configurations.

Example 14. The radio of Example 13, wherein the one or more predetermined operating conditions comprises at least one of undetectability, throughput, quality of service, and connectivity.

Example 15. A method of operating a radio, the method comprising: identifying transmission parameter data at a time period between successful communication of signal packets; storing the transmission parameter data in a buffer in a memory; passing the transmission parameter data to a multilayer process stored in the memory to determine a plurality of potential operating configurations comprising at least one of a power operational setting, a frequency operational setting, a multiple-input multiple-output operational setting, or a time operational setting; arbitrating the plurality of potential operating configurations to determine a final set of operating configurations; and updating operation of the radio based on the final set of operating configurations.

Example 16. The method of Example 15, wherein the transmission parameter data is identified after a failed data packet.

Example 17. The method of Example 15, wherein passing the transmission parameter data to the multilayer process comprises passing the transmission parameter data to the multilayer process when the buffer is full.

Example 18. The method of Example 15, wherein arbitrating the plurality of potential operating configurations comprising using at least on machine learning algorithm trained using stored information of interference simulations.

Example 19. The method of Example 15, wherein the multilayer process comprises two or more of a transmit power control engine, a noise-like spread signaling engine, a decoy relays engine, a directional radiation engine, an interference cancellation engine, or an interference avoidance engine.

Example 20. The method of Example 15, further comprising manipulating interference cancellation through processing information from multiple receive antennas of a multiple-input multiple output transceiver.

Example 21. A multiple-input multiple-output (“MIMO”) radio comprising: a transceiver configured to communicate signal packets; a memory configured to store a plurality of pretrained interference signal classifiers and a multilayer process; and one or more hardware processors in communication with the memory and configured to: identify an interference signal; determine if the interference signal corresponds to an interference signal classifier of the plurality of pretrained interference signal classifiers; determine a final set of operating configurations based on the interference signal classifier; and update operation of the MIMO radio based on the final set of operating configurations.

Example 22. The MIMO radio of Example 21, wherein to identify the interference signal, the one or more hardware processors are configured to detect a presence of the interference signal based on a covariance of multiple antennas of the transceiver.

Example 23. The MIMO radio of Example 21, wherein the one or more hardware processors are further configured to: determine the interference signal does not correspond to any of the plurality of pretrained interference signal classifiers; and store the interference signal in the memory.

Example 24. The MIMO radio of Example 23, wherein the one or more hardware processors are further configured to: train a new interference signal classifier based on at least the interference signal stored in the memory; and store the new interference signal classifier in the memory.

Example 25. A multiple-input multiple-output (“MIMO”) radio comprising: a transceiver configured to communicate signal packets; a memory configured to store a multilayer process and one or more machine learning algorithms; and one or more hardware processors in communication with the memory and configured to: identify transmission parameter data at a time period between successful communication of data packets; store the transmission parameter data in a buffer in the memory; when the buffer is full, pass the transmission parameter data to the multilayer process to determine a plurality of potential configuration settings comprising at least a power operational setting, a frequency operational setting, a space operational setting, or a time operation setting; determine, using the one or more machine learning algorithms, a final set of configuration settings based on at least the plurality of potential configuration settings; and update operation of the MIMO radio based on the final set of configuration settings.

Example 26. The MIMO radio of Example 25, wherein at least one machine learning algorithm of the one or more machine learning algorithms is trained using stored information of interference simulations.

Example 27. A multiple-input multiple-output (“MIMO”) radio comprising: a transceiver configured to send and receive signal packets from a different MIMO radio of a mobile ad-hoc network (MANET); a memory configured to store a multilayer process and at least one classifier; and one or more hardware processors in communication with the memory and configured to: identify transmission parameter data at a time period between successful communication of data packets; store the transmission parameter data in the memory; determine, using the multilayer process, a current performance information associated with the MIMO radio; determine, using the at least one classifier, a dynamic parameter setting; and update operation of the MIMO radio based on the dynamic parameter setting.

What is claimed is:

1. A radio comprising:
a transceiver configured to communicate signal packets;
a memory configured to store a multilayer process; and
one or more hardware processors in communication with the memory and configured to:
identify transmission parameter data at a time period between successful communications of the signal packets;
store the transmission parameter data in a buffer in the memory;
pass the transmission parameter data to the multilayer process to determine a plurality of potential operating configurations comprising at least one of a power operational setting, a frequency operational setting, a multiple-input multiple-output operational setting, or a time operational setting;
arbitrate the plurality of potential operating configurations to determine a final set of operating configurations; and
update operation of the radio based on the final set of operating configurations.

2. The radio of claim 1, wherein the transceiver is configured to communicate the signal packets with different multiple-input multiple-output (“MIMO”) radios of a mobile ad-hoc network (MANET).

3. The radio of claim 1, wherein the transmission parameter data is identified after a failed data packet.

4. The radio of claim 1, wherein the one or more hardware processors are configured to pass the transmission parameter data to the multilayer process when the buffer is full.

5. The radio of claim 1, wherein the one or more hardware processors are configured to continuously pass the transmission parameter data to the multilayer process.

6. The radio of claim 1, wherein the memory is further configured to store one or more machine learning algorithms, and wherein the one or more hardware processors are configured to arbitrate the plurality of potential operating configurations to determine the final set of operating configurations using at least one machine learning algorithm of the one or more machine learning algorithms.

7. The radio of claim 6, wherein the at least one machine learning algorithm of the one or more machine learning algorithms is trained using stored information of interference simulations.

8. The radio of claim 7, wherein the interference simulations include multiple configurations of interferes and geographic distributions of a plurality radios.

9. The radio of claim 7, wherein the one or more machine learning algorithms are further trained or re-trained using interference measurements collected in an environment over time.

10. The radio of claim 1, wherein the transmission parameter data comprises at least one of signal-to-noise ratio at the radio, detection of interference, jammer-to-noise ratio, jammer bandwidth, or throughput at the radio.

11. The radio of claim 1, wherein the multilayer process comprises two or more of a transmit power control engine, a noise-like spread signaling engine, a decoy relays engine, a directional radiation engine, an interference cancellation engine, or an interference avoidance engine.

12. The radio of claim 1, wherein the transceiver is configured for multiple-input multiple output (“MIMO) communication, and wherein the one or more hardware processors are further configured to manipulate interference cancellation through processing information from multiple receive antennas of the transceiver.

13. The radio of claim 1, wherein the one or more hardware processors are further configured to:
receive a user defined condition metric associated with one or more predetermined operating conditions for the radio; and
arbitrate the plurality of potential operating configurations and the user defined condition metric to determine the final set of operating configurations.

14. The radio of claim 13, wherein the one or more predetermined operating conditions comprises at least one of undetectability, throughput, quality of service, and connectivity.

15. A method of operating a radio, the method comprising:
identifying transmission parameter data at a time period between successful communication of signal packets;
storing the transmission parameter data in a buffer in a memory;
passing the transmission parameter data to a multilayer process stored in the memory to determine a plurality of potential operating configurations comprising at least one of a power operational setting, a frequency operational setting, a multiple-input multiple-output operational setting, or a time operational setting;
arbitrating the plurality of potential operating configurations to determine a final set of operating configurations; and
updating operation of the radio based on the final set of operating configurations.

16. The method of claim 15, wherein the transmission parameter data is identified after a failed data packet.

17. The method of claim 15, wherein passing the transmission parameter data to the multilayer process comprises passing the transmission parameter data to the multilayer process when the buffer is full.

18. The method of claim 15, wherein arbitrating the plurality of potential operating configurations comprising using at least on machine learning algorithm trained using stored information of interference simulations.

19. The method of claim 15, wherein the multilayer process comprises two or more of a transmit power control engine, a noise-like spread signaling engine, a decoy relays engine, a directional radiation engine, an interference cancellation engine, or an interference avoidance engine.

20. The method of claim 15, further comprising manipulating interference cancellation through processing information from multiple receive antennas of a multiple-input multiple output transceiver.
